(19) United States
(12) Patent Application Publication
(10) Pub. No.: US 2013/0151715 A1
(43) Pub. Date: Jun. 13, 2013

(54) COMMUNICATION APPARATUS THAT PERFORMS COMMUNICATION USING T.38 PROTOCOL, CONTROL METHOD THEREFOR, AND STORAGE MEDIUM

(71) Applicant: CANON KABUSHIKI KAISHA, Tokyo (JP)

(72) Inventor: Kaori Nakagawa, Yokohama-shi (JP)

(73) Assignee: CANON KABUSHIKI KAISHA, Tokyo (JP)

(21) Appl. No.: 13/673,059

(22) Filed: Nov. 9, 2012

(30) Foreign Application Priority Data
Dec. 7, 2011 (JP) 2011-267716

(51) Int. Cl. H04L 29/06

(52) U.S. Cl. CPC H04L 65/1069
USPC 709/227

(57) ABSTRACT

A communication apparatus which is capable of performing communications using the T.38 protocol by means of a SIP server that does not support the T.38 protocol. Audio is selected among a plurality of media types, and a first session establishment request for establishing a first session with a destination with which the communication apparatus is to communicate is transmitted to a SIP server. An address of the destination is obtained from a response transmitted from the SIP server in response to the first session establishment request. The first session established in response to the first session establishment request is disconnected. Image is selected among the plurality of media types, and a second session establishment request for communicating with the destination is transmitted to the destination using the obtained address. Image data is transmitted to the destination through the second session established in response to the second session establishment request.

### BACKGROUND OF THE INVENTION

1. Field of the Invention

The present invention relates to a communication apparatus, a control method therefor, and a computer-readable storage medium storing a control program for implementing the method.

2. Description of the Related Art

In recent years, methods that use IP networks as communication paths for facsimile communications have been established due to the widespread proliferation of the Internet and IP telephone. For example, call control protocols such as SIP (Session Initiation Protocol) that generate, modify, and disconnect sessions for real-time communications have been becoming the standard.

Moreover, the T.38 protocol that performs deemed audio communications in which communications are carried out by regarding modem signal tones as voices and real-time transmissions in which G3 facsimile (T.30) signals are converted into IP messages on IP networks have been recommended. The T.38 protocol conforms to T.38 recommended by ITU-T and sometimes called non-deemed audio communications as compared to deemed audio communications described above.

Facsimile communications using the T.38 protocol have advantages of decreasing bandwidth as compared to deemed audio communications that require audio bandwidth, and enabling high-speed communications because there is no need to modulate data into modem signals.

Also, an IP-PBX (internet protocol private branch exchange) has becoming widespread as an apparatus that exchanges lines for IP phones in a private IP network. An IP-PBX is an apparatus for realizing a house phone network using IP phones in a LAN in a company and provides call control of IP phones or the like using call control protocols such as SIP and H.323.

A real-time Internet facsimile apparatus can obtain an IP address of a communication destination using SIP by way of the IP-PBX and perform deemed audio communications using P2P or facsimile communications using the T.38 protocol with the communication destination.

There has been disclosed a technique to perform call connection by directly specifying an IP address of a destination's terminal without involving a SIP server when no SIP server is available for transmission by a real-time Internet facsimile apparatus (see, for example, Japanese Laid-Open Patent Publication (Kokai) No. 2009-135763).

This disclosed technique prompts an operator to input an IP address of a destination's terminal and performs call connection to the input IP address using SIP when no SIP server (IP-PBX) is available at the time of transmission.

However, although a real-time Internet facsimile apparatus is able to perform deemed audio communications using SIP and facsimile communications using SIP and the T.38 protocol, whether to perform deemed audio communications or use the T.38 protocol is determined on SIP.

On the other hand, an IP-PBX plays a role in acting as an intermediary to send SIP messages to a destination's terminal and posting a destination's IP address to a terminal.

Although an IP-PBX thus acts as an intermediary to send SIP messages, there are some IP-PBXs that do not support the T.38 protocol because of a limitation imposed on media (communication types) to be specified by SIP.

### SUMMARY OF THE INVENTION

The present invention provides a communication apparatus and a control method therefor, which are capable of performing communications using the T.38 protocol by means of a SIP server that does not support the T.38 protocol, as well as a computer-readable storage medium storing a control program for implementing the method.

Accordingly, a first aspect of the present invention provides a communication apparatus comprising a first transmission unit configured to select audio among a plurality of media types and transmit, to a SIP server, a first session establishment request for establishing a first session with a destination with which the communication apparatus is to communicate, an obtaining unit configured to obtain an address of the destination from a response transmitted from the SIP server in response to the first session establishment request transmitted from the first transmission unit, a disconnection unit configured to disconnect the first session with the destination established in response to the first session establishment request transmitted from the first transmission unit, a second transmission unit configured to select image among the plurality of media types and transmit a second session establishment request, which is for communicating with the destination, to the destination using the address obtained by the obtaining unit, and a third transmission unit configured to transmit image data to the destination through the second session with the destination established in response to the second session establishment request transmitted from the second transmission unit.

Accordingly, a second aspect of the present invention provides a control method for a communication apparatus, comprising a first transmission step of selecting audio among a plurality of media types and transmitting, to a SIP server, a first session establishment request for establishing a first session with a destination with which the communication apparatus is to communicate, an obtaining step of obtaining an address of the destination from a response transmitted from the SIP server in response to the first session establishment request transmitted in the first transmission step, a disconnection step of disconnecting the first session with the destination established in response to the first session establishment request transmitted in the first transmission step, a second transmission step of selecting image among the plurality of media types and transmitting a second session establishment request, which is for communicating with the destination, to the destination using the address obtained in the obtaining step, and a third transmission step of transmitting image data to the destination through the second session with the destination established in response to the second session establishment request transmitted in the second transmission step.

Accordingly, a third aspect of the present invention provides a non-transitory computer-readable storage medium storing a program for implementing a control method for a communication apparatus, the control method comprising a first transmission step of selecting audio among a plurality of media types and transmitting, to a SIP server, a first session establishment request for establishing a first session with a destination with which the communication apparatus is to communicate, an obtaining step of obtaining an address of the destination from a response transmitted from the SIP server in response to the first session establishment request transmitted in the first transmission step, a disconnection step of disconnecting the first session with the destination established in response to the first session establishment request transmitted in the first transmission step, a second transmission step of selecting image among the plurality of media types and transmitting a second session establishment request, which is for communicating with the destination, to the destination using the address obtained in the obtaining step, and a third transmission step of transmitting image data to the destination through the second session with the destination established in response to the second session establishment request transmitted in the second transmission step.

According to the present invention, communications using the T.38 protocol can be performed by means of a SIP server that does not support the T.38 protocol.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of a communication apparatus according to an embodiment of the present invention.

FIG. 2 is a functional block diagram showing the communication apparatus appearing in FIG. 1.

FIG. 3 is a sequence diagram showing a case where there is an attempt to perform a T.38 communication by way of an IP-PBX that does not support T.38 communications.

FIG. 4 is a sequence diagram showing the procedure of a transmission process in which the communication apparatus appearing in FIG. 1 performs a T.38 communication by way of an IP-PBX that does not support T.38 communications.

FIG. 5 is a flowchart showing the procedure of a transmission process carried out by a CPU appearing in FIG. 1.

### DESCRIPTION OF THE EMBODIMENTS

The present invention will now be described in detail with reference to the drawings showing an embodiment thereof.

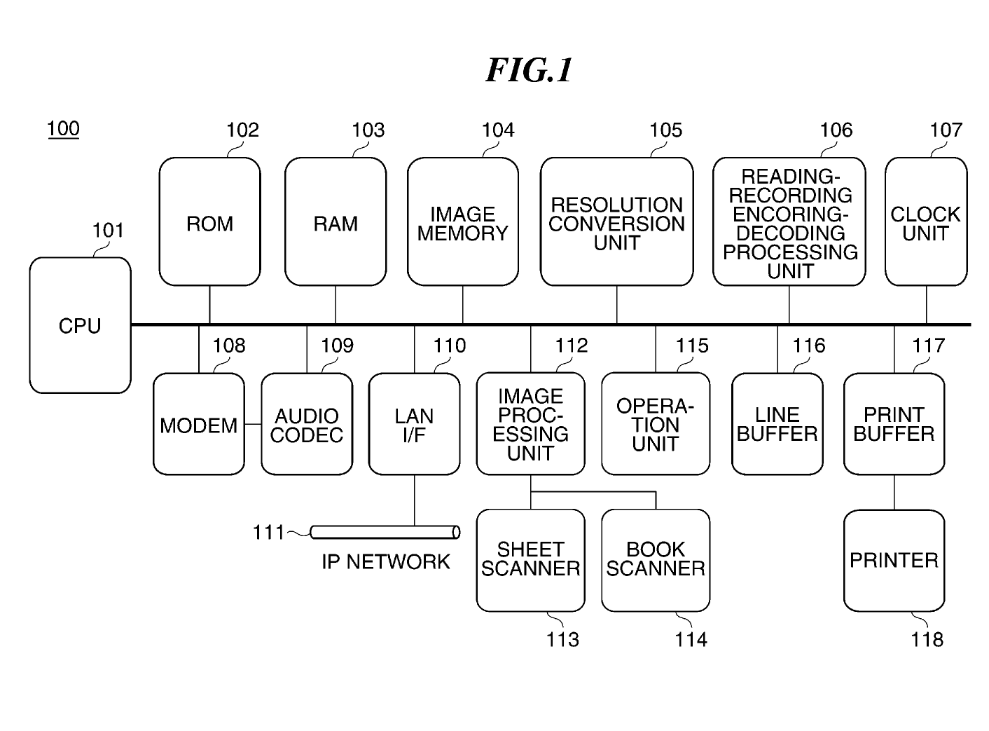

FIG. 1 is a diagram schematically showing an arrangement of a communication apparatus 100 according to an embodiment of the present invention.

Referring to FIG. 1, the communication apparatus 100 communicates with an IP network 111 such as a private branch IP or an NGN. A CPU 101, which is a system controller, controls the entire apparatus. A ROM 102 stores a control program for the CPU 101, a program for carrying out a transmission process, to be described later, and so on. A RAM 103, which is comprised of an SRAM or the like, is used as a work area by the CPU 101 and used to store image data and others. An image memory 104, which is comprised of a DRAM, stores image data and others.

A resolution conversion processing unit 105 provides resolution conversion control such as millimeter-inch resolution conversion of raster data. A reading-recording encoding-decoding processing unit 106 carries out an encoding process and a decoding process on image data handled by the communication apparatus 100. A clock unit 107, which is comprised of an IC or the like, measures operation intervals, for example.

A modem 108 demodulates a modulated signal received from the IP network 111 and modulates a signal to send out the same to the IP network 111. An audio codec 109 encodes an audio signal and decodes an encoded audio signal. Specifically, the audio codec 109 supports audio encoding schemes such as G.711 and G.729. A LAN I/F 110 provides control for communications with the IP network 111.

A sheet scanner 113 and a book scanner 114, which are comprised of a CS image sensor, an original conveying mechanism, and so on, optically read an original, convert the same into electric image data, and output the image data. They are also capable of reading double-sided originals. An image processing unit 112 carries out a correction process on image data output from the sheet scanner 113 or the book scanner 114 and outputs high-resolution image data.

A line buffer 116 is used to control transfer of image data. A print buffer 117 is a buffer memory for one page, which is used to store character codes for printing. A printer 118 is a printer such as an LBP which records received images and file data on plain sheets, and capable of carrying out double-sided recording.

An operation unit 115 is comprised of a keyboard, a display, and so on and subjected to various input operations by an operator.

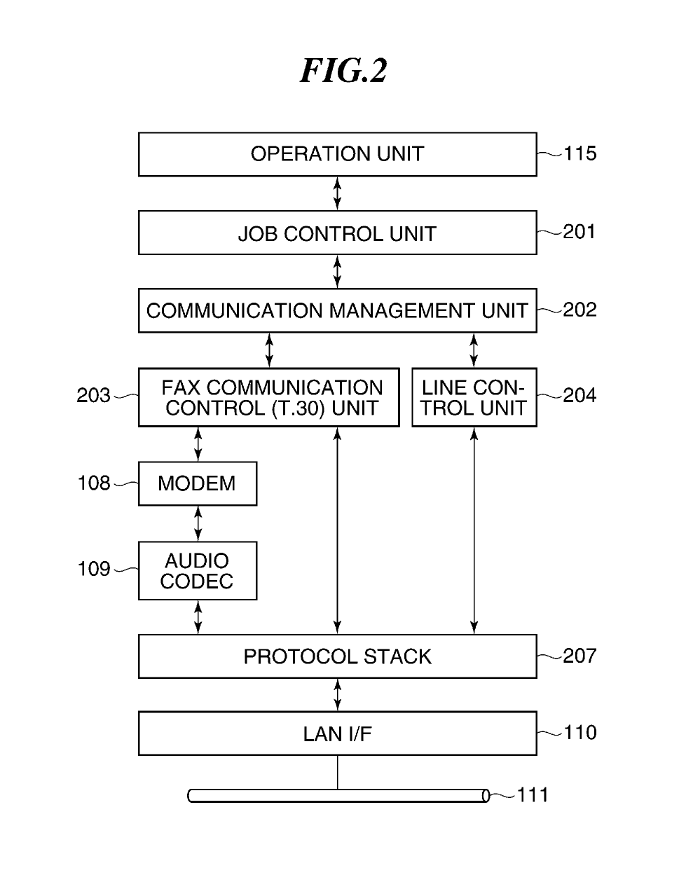

FIG. 2 is a functional block diagram showing the communication apparatus 100 appearing in FIG. 1.

The communication apparatus 100 according to the present embodiment is configured to be capable of performing FAX transmission using various schemes so as to use in combination of deemed audio communications using a G3 facsimile application and communications using the T.38 protocol. In the following description, communications using the T. 38 protocol will be referred to merely as T. 38 communications.

Referring to FIG. 2, when a deemed audio communication is to be performed, a facsimile communication by a deemed audio communication is selected via the operation unit 115. A job control unit 201 generates a transmitting/calling job by IP telephone.

A line control unit 204 prompts a protocol stack 207 to connect with a destination using SIP because an ongoing call is over IP telephone. A SIP message created by the protocol stack 207 is transmitted to the IP network 111 through the LAN I/F 110.

When an audio session with the destination is generated using SIP, voice input to the communication apparatus 100 is encoded through the audio codec 109 and transmitted to the IP network 111 using RTP (Rea-time Transport Protocol) of the protocol stack 207.

In response to a transmission starting operation via the operation unit 115, a FAX communication control unit 203 starts a facsimile communication. Facsimile procedure signals and image data generated through the modem 108 are encoded by the audio codec 109 and transmitted to a destination using RTP of the protocol stack 207.

On the other hand, when a T.38 communication is to be performed, a T.38 communication is selected via the operation unit 115. A T.38 transmission job is generated by the job control unit 201. Through the line control circuit 204, a communication management unit 202 prompts the protocol stack 207 to connect with a destination using SIP.

A SIP message created by the protocol stack 207 is transmitted to the IP network 111 through the LAN I/F 110. When a session with the destination is generated using SIP, the communication management unit 202 performs a facsimile procedure for faxing to the destination in accordance with the T.38 protocol.

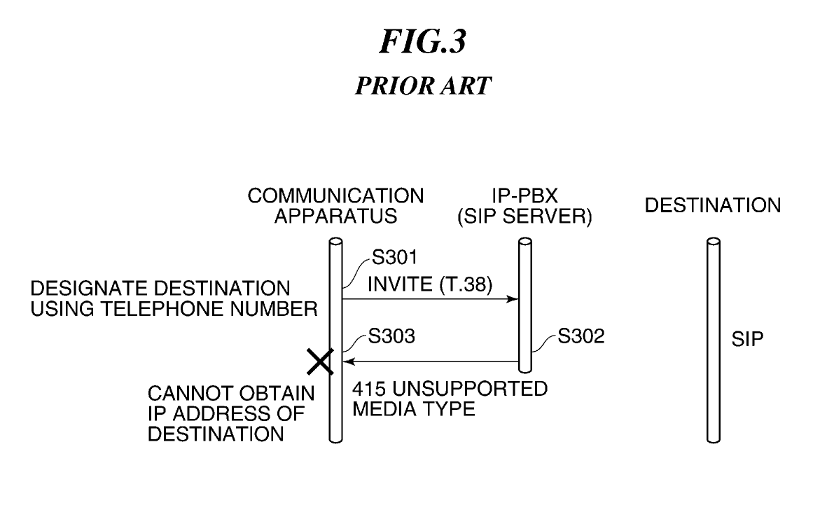

FIG. 3 is a sequence diagram showing a case where according to a prior art, there is an attempt to perform a T.38 communication by way of an IP-PBX (SIP server) that does not support T.38 communications.

A communication apparatus sends out an INVITE request (session establishment request) by way of an IP-PBX so as to perform a T. 38 communication (step S301). The IP-PBX sends back a response such as a 415 Unsupported Media Type (a media type that is not supported) without posting the INVITE request to a destination (step S302).

Because a communication by T.38 media is rejected by the IP-PBX, the communication apparatus cannot obtain an IP address of the destination, and the communication ends in failure (step S303).

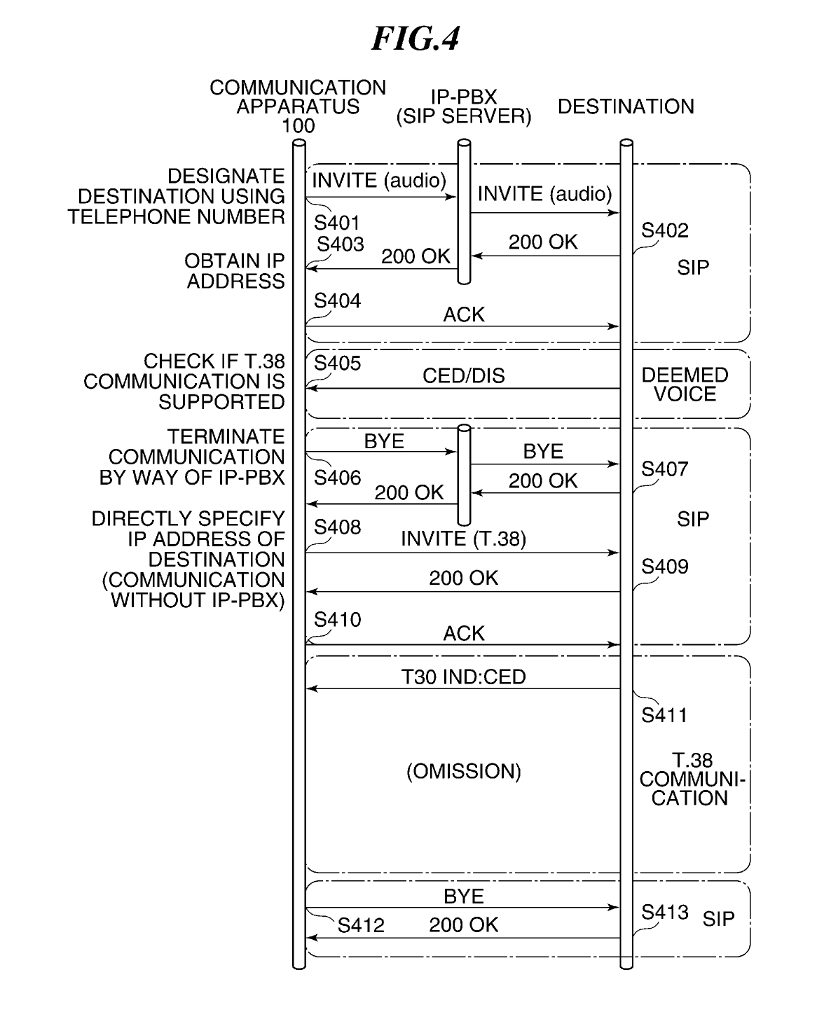

FIG. 4 is a sequence diagram showing the procedure of a transmission process in which the communication apparatus 100 appearing in FIG. 1 performs a T.38 communication by way of an IP-PBX that does not support T.38 communications.

Referring to FIG. 4, because the IP-PBX does not support T.38 communications, the communication apparatus 100 transmits an INVITE request (session establishment request) with media type (m) being “audio” so as to establish a connection for an audio communication (step S401).

A destination sends back a 200 OK (success) response (step S402) to notify that the request has successfully been met. Upon receiving a 200 OK (success), the communication apparatus 100 obtains and stores an IP address (step S403).

In response to ACK (acknowledgement) from the communication apparatus 100, a session of m=audio is generated, and a deemed audio communication is started (step S404).

The communication apparatus 100 obtains a DIS signal from a destination, and based on the received DIS signal, ascertains whether or not the destination supports T. 38 communications (step S405). Upon ascertaining that the destination supports T. 38 communications, the communication apparatus 100 sends a BYE (disconnect) (step S406), and the destination sends back a 200 OK (success), followed by termination of the deemed audio communication (step S407).

Then, to perform a T. 38 communication, the communication apparatus 100 transmits an INVITE request with media type (m) being “image” directly to the destination without using the IP-PBX and requests the destination to generate a session of m=image (step S408).

The destination sends back a 200 OK (success) response (step S409), and in response to an ACK (acknowledgement) sent from the communication apparatus 100 (step S410), a session of m=image is generated to start a T.38 communication (step S411).

After completion of the T.38 communication, the communication apparatus 100 transmits a BYE (disconnect) (step S412), and the destination sends back a 200 OK (success), followed by termination of the T.38 communication (step S413).

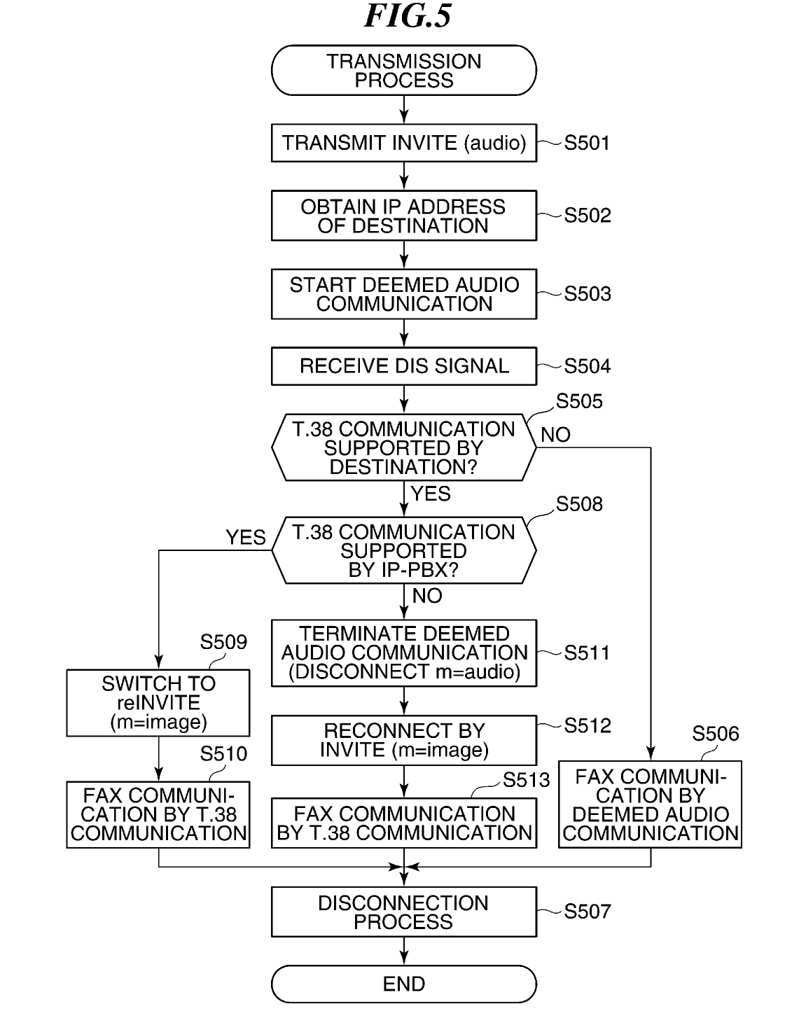

FIG. 5 is a flowchart showing the procedure of a transmission process carried out by the CPU 101 appearing in FIG. 1.

It should be noted that in the present embodiment, it is assumed that an IP-PBX does not support T.38 communications, but the process in this flowchart encompasses a case where an IP-PBX supports T.38 communications. The process in this flowchart also encompasses a case where a destination does not support T.38 communications.

Referring to FIG. 5, first, the CPU 101 transmits an INVITE request, described above, with media type (m) being “audio” to a destination via the IP-PBX so that the IP-PBX can establish a connection for an audio communication (step S501). This step S501 corresponds to a first transmission unit that transmits, to a SIP server, a session establishment request for establishing a session with a destination with media type being “audio”.

Next, the CPU 101 obtains an IP address of the destination using SIP and stores the same in the RAM 103 (step S502). This step S502 corresponds to an obtaining unit that obtains an address of a destination from a response transmitted from a SIP server in response to a session establishment request.

As a result, a session of m=audio with the destination is established to start a deemed audio communication (step S503).

The CPU 101 receives a DIS signal from the destination (step S504), and based on the received DIS signal (bit 3), determines whether or not the destination supports T.38 communications (step S505: first determination unit).

When, as a result of the determination in the step S505, the destination supports T.38 communications (YES in the step S505), the CPU 101 further determines whether or not the IP-PBX supports T.38 communications (step S508: second determination unit).

When, as a result of the determination in the step S508, the IP-PBX does not support T.38 communications (NO in the step S508), the CPU 101 terminates the deemed audio communication (step S511). This step S511 corresponds to a disconnecting unit that disconnects a session with a destination, which has been established in response to a transmitted session establishment request.

Then, to perform a T.38 communication, the CPU 101 establishes a connection again by transmitting an INVITE request with media type (m) being “image” to the IP address of the destination (step S512) and performs a facsimile communication using T.38 to transmit image data (step S513).

The step S512 described above corresponds to a second transmission unit that transmits a session establishment request, which is for communicating with a destination with media type being “image”, to the destination using an obtained address. The step S513 described above corresponds to a third transmission unit that transmits a facsimile to a destination according to the T. 38 protocol by a session with the destination established in response to a transmitted session establishment request.

When the transmission of the facsimile is completed, the CPU 101 carries out a disconnecting process (step S507) and terminates the present process.

On the other hand, when, as a result of the determination in the step S505, the destination does not support T.38 communications (NO in the step S505), the CPU 101 performs a facsimile communication by a deemed audio communication to transmit image data (step S506) and proceeds to the step S507 described above. In this way, upon determining that a destination does not support T.38 communications, the CPU 101 does not disconnect a session but transmits image data to the destination using a session established in response to a session establishment request transmitted in the step S501.

Also, when, as a result of the determination in the step S508, the IP-PBX supports T.38 communications (YES in the step S508), the CPU 101 transmits a reINVITE request, described above, with media type (m) being “image” by way of the IP-PBX (step S509).

Thus, the CPU 101 switches media types and performs a facsimile communication using T.38 to transmit image data (step S510) and proceeds to the step S507 described above. In this way, upon determining that a SIP server supports the T.38 protocol, the CPU 101 does not disconnect a session but transmits image data to a destination using a session established in response to a session establishment request transmitted in the step S501. Also, upon determining that a SIP server supports the T.38 protocol, the CPU 101 switches the media type of a session, which has been established in response to a session establishment request transmitted in the step S501, to image (switching unit).

Although in the above description of the embodiment, the expression that an IP-PBX “does not support T.38 communications” is used, this expression encompasses a case where an IP-PBX supports T.38 communications but a limitation is imposed on T.38 communications. This expression also encompasses a case where a limitation is imposed on T.38 communications by imposing a limitation on communication types.

According to the process in FIG. 5, first, the CPU 101 transmits, to a SIP server, a session establishment request for establishing a session with media type being “audio” (step S501). Then, the CPU 101 obtains an address of the destination from a response transmitted from a SIP server in response to the session establishment request (step S502).

Next, the CPU 101 disconnects the session with the destination established in response to the transmitted session establishment request (step S511), and transmits a session establishment request, which is for communicating with the destination with media type being “image”, to the destination using the obtained address (step S512).

Then, the CPU 101 transmits image data to the destination through the session with the destination established in response to the transmitted session establishment request. As a result, a communication using the T.38 protocol can be performed using the SIP server that does not support the T.38 protocol. This can compress network bandwidth required for faxing, or enables higher-speed communications.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-267716 filed Dec. 7, 2011, which is hereby incorporated by reference herein in its entirety.

What is claimed is:

1. A communication apparatus comprising:
a first transmission unit configured to select audio among a plurality of media types and transmit, to a SIP server, a first session establishment request for establishing a first session with a destination with which the communication apparatus is to communicate;
an obtaining unit configured to obtain an address of the destination from a response transmitted from the SIP server in response to the first session establishment request transmitted from said first transmission unit;
a disconnection unit configured to disconnect the first session with the destination established in response to the first session establishment request transmitted from said first transmission unit;
a second transmission unit configured to select image among the plurality of media types and transmit a second session establishment request, which is for communicating with the destination, to the destination using the address obtained by said obtaining unit; and
a third transmission unit configured to transmit image data to the destination through the second session with the destination established in response to the second session establishment request transmitted from said second transmission unit.

2. A communication apparatus according to claim 1, wherein said first transmission unit transmits the first session establishment request by a deemed audio communication, and
said second transmission unit transmits the second session establishment request using T.38 protocol.

3. A communication apparatus according to claim 2, further comprising a first determination unit configured to determine whether the destination supports T.38 protocol,
wherein when said first determination unit determines that the destination does not support T.38 protocol, said disconnection unit does not disconnect the first session, and said third transmission unit transmits image data to the destination using the first session established in response to the first session establishment request transmitted from said first transmission unit.

4. A communication apparatus according to claim 2, further comprising a second determination unit configured to determine whether the SIP server supports T.38 protocol,
wherein when said second determination unit determines that the SIP server supports T.38 protocol, said disconnection unit does not disconnect the first session, and said third transmission unit transmits image data to the destination using the first session established in response to the first session establishment request transmitted from said first transmission unit.

5. A communication apparatus according to claim 4, further comprising a switching unit configured to, when said second determination unit determines that the SIP server supports T.38 protocol, switch the media type of the first session, which has been established in response to the first session establishment request transmitted from said first transmission unit, to image.

6. A control method for a communication apparatus, comprising:
a first transmission step of selecting audio among a plurality of media types and transmitting, to a SIP server, a first session establishment request for establishing a first session with a destination with which the communication apparatus is to communicate;
an obtaining step of obtaining an address of the destination from a response transmitted from the SIP server in response to the first session establishment request transmitted in said first transmission step;
a disconnection step of disconnecting the first session with the destination established in response to the first session establishment request transmitted in said first transmission step;
a second transmission step of selecting image among the plurality of media types and transmitting a second session establishment request, which is for communicating with the destination, to the destination using the address obtained in said obtaining step; and
a third transmission step of transmitting image data to the destination through the second session with the destination established in response to the second session establishment request transmitted in said second transmission step.

7. A non-transitory computer-readable storage medium storing a program for implementing a control method for a communication apparatus, the control method comprising:
a first transmission step of selecting audio among a plurality of media types and transmitting, to a SIP server, a first session establishment request for establishing a first session with a destination with which the communication apparatus is to communicate;
an obtaining step of obtaining an address of the destination from a response transmitted from the SIP server in response to the first session establishment request transmitted in the first transmission step;
a disconnection step of disconnecting the first session with the destination established in response to the first session establishment request transmitted in the first transmission step;
a second transmission step of selecting image among the plurality of media types and transmitting a second session establishment request, which is for communicating with the destination, to the destination using the address obtained in the obtaining step; and
a third transmission step of transmitting image data to the destination through the second session with the destination established in response to the second session establishment request transmitted in the second transmission step.
